(19) United States
(12) Patent Application Publication
(10) Pub. No.: US 2006/0236988 A1
(43) Pub. Date: Oct. 26, 2006

(54) Efficiency Increase in Internal Combustion Engines Powered by Hydrogen

(76) Inventor: Robert Adler, Gerasdorf (AT)

Correspondence Address: CROWELL & MORING LLP;INTELLECTUAL PROPERTY GROUP, P.O. BOX 14300, WASHINGTON, DC, 20044-4300, US

(21) Appl. No.: 10/535,693

(22) PCT Filed: Nov. 14, 2003
(86) PCT No.: PCT/EP03/12757

§ 371 Date: Apr. 20, 2006

(30) Foreign Application Priority Data
Nov. 20, 2002 (DE) 102 54 156.6

(51) Int. Cl. F02G 5/00; F02B 43/00

(52) U.S. Cl. 123/543; 123/527; 123/557

(57) ABSTRACT

A method is disclosed for the introduction of a combustible medium, in particular a cryogenic medium such as hydrogen, into an internal combustion engine. According to the invention, the medium is heated before the introduction thereof into the internal combustion engine at least to ambient temperature, preferably to a temperature of at least 500° C., and introduced into the internal combustion engine at a pressure of between 100 and 500 bar. The heating of the medium is preferably achieved at least partly in heat exchange with the or an exhaust stream from the internal combustion engine.

### BACKGROUND AND SUMARY OF THE INVENTION

This invention relates to a process for introducing a medium that is combustible in a combustion engine, especially a cryogenic medium such as hydrogen, into a combustion engine.

Similar processes for introducing a medium, especially a cryogenic medium, into a combustion engine, exclusively used hydrogen. Modified combustion engines have usually used hydrogen-suction-tube injection systems which essentially correspond to the conventional suction-tube-injection systems used in conventional combustion-engines.

Because of the poor efficiency of combustion engines of this type using hydrogen-suction-tube-injection, the use of common rail high pressure injection systems is currently being tested.

Although a common rail high pressure injection system will not significantly improve the efficiency of a combustion engine, the use of such a system can increase displacement.

The disadvantage of the combustion engines with hydrogen suction tube injection currently used is that the gaseous hydrogen in the suction tubes displace considerable portions of the intake air thereby reducing the available volume of oxygen required for combustion. As a result, the displacement of a hydrogen-powered combustion engine with suction tube injection is significantly lower than that of a gasoline or diesel-powered engine.

### DETAILED DESCRIPTION OF THE INVENTION

In high-pressure injection of gaseous hydrogen in a closed cylinder when a valve or valves are closed, this disadvantage is overcome. To reduce the energy required for compression, the gaseous hydrogen is injected into the closed cylinder preferably just prior to top dead center of the piston.

The temperature of the intake air in the top dead center is approximately 275° C. If cold hydrogen is injected into the combustion chamber of the cylinder at this point, the compression temperature decreases and the energy required for compression is cancelled.

One object of the submitted invention is to propose a process for introducing a medium, especially a cryogenic medium, into a combustion chamber in such a way that avoids the disadvantages listed above.

In a process for solving this problem, prior to being introduced into the combustion chamber, the medium is heated to at least 500° C. and is then introduced into the combustion chamber at a pressure between 100 and 500 bar, preferably between 200 and 300 bar.

The high temperature, to which the medium introduced into the combustion chamber is introduced, is also determined based on whether the air/medium mixture formed in the cylinder is ignited by outside energy or is self-igniting.

In principle, the temperature to which the medium introduced to the combustion chamber is heated cannot be high enough. The maximum temperature limit is determined in each case by the type of medium.

Especially when liquid hydrogen is used as fuel, the required injection pressure of 100 to 500 bar can be efficiently achieved in the hydrogen storage container while the medium is still in the fluid phase.

According to an advantageous configuration of the inventive process for introducing a medium into a combustion agent, the medium is heated prior being introduced into the combustion engine at least partly from heat exchange with the single exhaust gas stream, or a single one of the exhaust gas streams, of the combustion engine.

Along with the configuration of the inventive process described above, alternative or supplemental processes, such as, for example, electrical heating, heating through combustion of a portion of the medium, etc, can be considered. These alternative or supplemental processes are advantageously used primarily during the starting phase of the combustion engine.

The inventive process for introducing a medium into a combustion chamber allows the efficiency of a combustion engine to be increased up to approximately 50%. Each increase in efficiency, however, is a function of the selected compression ratio as well as the selected injection pressure.

The concept described above is for use with all mediums used as fuel, which do not fail or crack at the temperatures realized. When these fuels are used, the pressure is increased in the fluid phase and afterwards dampened in front of the injection nozzle.

If gaseous fuels, such as natural gas of GH₂, are used, only a portion of the energy can be yielded, since the fuel must be compressed. However, this is aided by the fuel tank pressure in the storage container.

1-3. (canceled)

4. A process for introducing a medium that can be burned into a combustion engine, comprising:
heating the medium to at least a surrounding temperature prior to introduction of the medium into the combustion engine, and
introducing the heated medium into the combustion engine at a pressure between 100 and 500 bar.

5. The process as claimed in claim 4, wherein the heated medium is introduced into the combustion engine at a pressure between 200 and 300 bar.

6. The process as claimed in claim 4, wherein the medium is heated at least partly by heat exchange with a single exhaust stream present in the combustion engine.

7. The process as claimed in claim 5, wherein the medium is heated at least partly by heat exchange with a single exhaust stream present in the combustion engine.

8. The process as claimed in claim 4, wherein the medium is a cryogenic medium.

9. The process as claimed in claim 8, wherein the medium is hydrogen.

10. The process as claimed in claim 4, wherein the medium is heated to at least 500° C. prior to introduction thereof into the combustion engine.

11. The process as claimed in claim 6, wherein the single exhaust stream is one of multiple exhaust streams present in the combustion engine.
